(19) United States
(12) Patent Application Publication
(10) Pub. No.: US 2017/0028496 A1
(43) Pub. Date: Feb. 2, 2017

(54) BRAZING ASSEMBLY FOR ROOF LASER-BRAZING SYSTEM

(71) Applicants: HYUNDAI MOTOR COMPANY, Seoul (KR); KIA MOTORS CORPORATION, Seoul (KR)

(72) Inventors: Taeheun JIN, Gyeongsan-si (KR); Minsun SIM, Incheon (KR)

(73) Assignees: HYUNDAI MOTOR COMPANY, Seoul (KR); KIA MOTORS CORPORATION, Seoul (KR)

(21) Appl. No.: 14/964,770

(22) Filed: Dec. 10, 2015

(30) Foreign Application Priority Data
Jul. 31, 2015 (KR) 10-2015-0108917

(51) Int. Cl. B23K 1/005; B23K 1/00; B23K 3/04; B62D 27/02; B23K 26/08; B23K 26/14; B23K 26/03; B23K 1/14; B23K 3/06

(52) U.S. Cl. CPC B23K 1/0056; B23K 1/14; B23K 1/0008; B23K 3/04; B23K 3/063; B23K 26/0876; B23K 26/14; B23K 26/03; B62D 27/02; B60Y 2410/124

(57) ABSTRACT

A brazing assembly for a roof laser-brazing system includes: i) a brazing bracket configured to be mounted to a brazing robot in a brazing section; ii) a laser head mounted to the brazing bracket and configured to emit a laser beam to irradiate a bonding portion of a side panel and a bonding portion of a roof panel; and iii) a wire feeder mounted to the brazing bracket and configured to supply a filler wire to a focal position of the laser beam.

### CROSS-REFERENCE TO RELATED APPLICATION

This application claims priority to Korean Patent Application No. 10-2015-0108917 filed on Jul. 31, 2015 in the Korean Intellectual Property Office, the entire contents of which is incorporated herein by reference.

### FIELD

The present disclosure relates to a vehicle body assembling system, and more particularly, to a roof laser-brazing system for assembling a side panel and a roof panel of a vehicle body.

### BACKGROUND

Generally, a vehicle body goes through a vehicle body assembling process of assembling various product panels produced in vehicle body sub-processes to have a body in white (B.I.W) form.

The vehicle body may include a floor panel forming a lower surface of a frame, two side panels forming left and right side surfaces of the frame, a roof panel forming an upper surface of the frame, a plurality of roof rails, a cowl panel, a back panel, a package tray, etc. An assembly of vehicle body parts is performed by a main buck process (referred to as a vehicle body build-up process in the art).

In the main buck process, the assembling includes bonding the back panel to the floor panel by the vehicle body assembling system and then welding both side panels, the roof panels, the roof rails, the cowl panel, the package tray, etc.

The vehicle body assembling system controls the side panel by using a side hanger and a side gate to set the side panel to the floor panel, and sets the roof panels, the roof rails, the cowl panel, the package tray, etc., to the side panel, and then welds bonded portions thereof to each other by a welding robot.

In the vehicle body assembling process described above, the roof panels are bonded to the side panels by spot welding, and then roof molding made of a resin material is attached to bonded portions of the side panels and the roof panels.

However, the related art attaches the roof molding to the bonded portions of the side panels and the roof panels such that the appearance may not be aesthetically pleasing, and material costs and personnel expenses due to the mounting of the roof molding may be increased.

The above information disclosed in this Background section is only for enhancement of understanding of the background of the disclosure and therefore it may contain information that does not form prior art that already known to a person of ordinary skill in the art.

### SUMMARY

The present disclosure has been made in an effort to provide a brazing assembly for a roof laser-brazing system that allows for omission of a roof molding by bonding a bonding portion of a side panel with a roof panel using a laser-brazing method.

An exemplary form of the present disclosure provides a brazing assembly for a roof laser-brazing system, the roof laser-brazing system including a brazing section and a grinding section set along a transfer path of a body to bond a roof panel to two side panels based on the body including both side panels, the brazing assembly configured to, when both side panels and the roof panel are fixedly positioned by side panel fixed-positioning jigs and a roof pressing jig, bond one of the side panels to the roof panel by brazing a bonding portion of one of the side panels and a bonding portion of the roof panel using a laser as a heat source, the brazing assembly for the roof laser-brazing system including: i) a brazing bracket configured to be mounted to at least one brazing robot in the brazing section; ii) a laser head mounted to the brazing bracket and configured to emit a laser beam to irradiate the bonding portion of one of the side panels and the bonding portion of the roof panel; and iii) a wire feeder mounted to the brazing bracket and configured to supply a filler wire to a focal position of the laser beam.

The brazing bracket may be connected to a gap measurement unit configured to measure a matching gap between the roof panel and one of the side panels.

The brazing bracket may have a U-shape, and corner portions of the brazing bracket may be connected to reinforcing plates.

The gap measurement unit may include a profile sensor mounted to the brazing bracket and configured to scan matching portions of one of the side panels and of the roof panel to measure a gap between the matching portions.

The profile sensor may be configured to: set a virtual reference line based on a straight portion of the roof panel; calculate an interval between profiles generated on the reference line; and measure the matching gap between the roof panel and one of the side panels.

The profile sensor may be mounted to the brazing bracket and configured to be moved forward and backward by an operating cylinder.

The brazing bracket may be fixedly mounted to an operating cylinder, and an operating rod of the operating cylinder may be connected with the sensor bracket to which the profile sensor is fixed.

The operating cylinder may be connected to a pair of guide bars configured to guide the sensor bracket when the sensor bracket is moved forward and backward by the operating rod.

The sensor bracket may be connected to an air blower configured to inject air.

The sensor bracket may comprise an air injection path connected to the air blower, and the brazing assembly may be configured to inject air through the air injection path in a direction vertical to an irradiation direction of a laser beam.

The air injection path may be formed in the sensor bracket along a vertical direction and configured to inject air through a lower end thereof.

### DRAWINGS

Since the accompanying drawings are provided only to describe exemplary forms of the present disclosure, it is not to be interpreted that the spirit of the present disclosure is limited to the accompanying drawings.

FIG. 1 is a block diagram schematically illustrating a roof laser-brazing system.

FIGS. 2 to 4 are diagrams illustrating side panel fixed-positioning jigs for use with the roof laser-brazing system.

FIG. 5 is a perspective view illustrating clampers of the side panel fixed-positioning jigs for use with the roof laser-brazing system.

FIG. 6 is a perspective view illustrating fixed pin portions of the side panel fixed-positioning jigs for use with the roof laser-brazing system.

FIGS. 7 to 9 are diagrams illustrating a roof pressing jig for use with the roof laser-brazing system.

FIG. 10 is a perspective view illustrating a docking bracket portion of the roof pressing jig for use with the roof laser-brazing system.

FIG. 11 is a perspective view illustrating a vacuum cup portion of the roof pressing jig for use with the roof laser-brazing system.

FIG. 12 is a perspective view illustrating a control pin portion of the roof pressing jig for use with the roof laser-brazing system.

FIG. 13 is a perspective view illustrating a reference pin portion of the roof pressing jig for use with the roof laser-brazing system.

FIG. 14 is a diagram schematically illustrating a laser-brazing principle of a brazing assembly for use with the roof laser-brazing system.

FIGS. 15 to 17 are diagrams illustrating the brazing assembly and a gap measurement unit for use with the roof laser-brazing system.

FIG. 18 is a diagram illustrating an air injection structure of the brazing assembly for use with the roof laser-brazing system.

FIGS. 19 and 20 are coupled perspective views illustrating a grinding assembly for use with the roof laser-brazing system.

FIG. 21 is an exploded perspective view illustrating the grinding assembly for use with the roof laser-brazing system.

FIG. 22 is a coupled cross-sectional view illustrating the grinding assembly for use with the roof laser-brazing system.

FIG. 23 is a diagram illustrating a bead checking unit for use with the roof laser-brazing system.

<Description of symbols>

| | | | |
|---|---|---|---|
| 1 | Body | 3 | Side panel |
| 5 | Roof panel | 6a | Control hole |
| 6b | Reference hole | 7 | Transport line |
| 8 | Brazing section | 9 | Grinding section |
| 100 | Roof laser-brazing system | 101 | Roof alignment jig |
| 103 | Roof loading jig | 105 | Welding robot |
| 200 | Side panel fixed-positioning jig | 210 | Base frame |
| 220 | Moving frame | 221 | Guide rail |
| 223 | Slider | 225 | First driving unit |
| 227 | First servo motor | 229 | Lead screw |
| 230 | Post frame | 233 | Support bracket |
| 235 | Fixed pin | 237 | Pin clamper |
| 238 | Pin clamping cylinder | 240 | Support frame |
| 241 | Driving motor | 250 | Clamper |
| 251 | Clamp cylinder | 253 | Second driving unit |
| 255 | Second servo motor | 257 | LM guide |
| 258 | Moving block | 259 | Rail member |
| 300 | Roof pressing jig | 301 | Handling robot |
| 310 | Jig frame | 311 | Main frame |
| 313 | Sub frame | 315 | Robot coupling part |
| 317 | Docking bracket | 319 | Pin hole |
| 320 | Control pad | 325, | Through hole |
| | | 673 | |
| 330 | Vacuum cup | 331 | Fixed bracket |
| 333 | Mounting rod | 335 | Spring |
| 340 | Control pin | 341 | Control pin cylinder |
| 343 | Control pin operating rod | 345 | Control bracket |
| 360 | Reference pin | 361 | Reference pin cylinder |
| 363 | Reference pin operating rod | 400 | Brazing assembly |
| 401 | Brazing robot | 403 | Laser beam |
| 405 | Filler wire | 410 | Brazing bracket |
| 411 | Reinforcing plate | 430 | Laser head |
| 450 | Wire feeder | 500 | Gap measurement unit |
| 510 | First profile sensor | 511 | Sensor bracket |
| 520 | Operating cylinder | 521 | Operating rod |
| 525 | Guide bar | 527 | Fixed block |
| 550 | Air blower | 555 | Air injection path |
| 600 | Grinding assembly | 601 | Grinding robot |
| 603 | Support means | 610 | Grinding bracket |
| 615, | Guide groove | 620 | Grinding motor |
| 641 | | | |
| 621 | Driving shaft | 630 | Grinding wheel |
| 640 | Wheel cover | 645 | Inlet |
| 650 | Moving plate | 651 | Bushing |
| 653 | Rail block | 655 | Sliding block |
| 660 | Pressure control cylinder | 661 | Mounting bracket |
| 663 | Pressure control rod | 670 | Stopper cylinder |
| 671 | Stopper operating rod | 675 | Friction pad |
| 700 | Bead checking unit | 710 | Mounting bracket |
| 717 | Beam passing hole | 730 | Vision camera |
| 731 | Illumination unit | 750 | Second profile sensor |

### DETAILED DESCRIPTION

The present disclosure will be described more fully hereinafter with reference to the accompanying drawings, in which exemplary forms of the disclosure are shown. As those skilled in the art would realize, the described forms may be modified in various different ways, all without departing from the spirit or scope of the present disclosure.

In order to clearly describe the present disclosure, portions that are not connected with the description will be omitted. Like reference numerals designate like elements throughout the specification.

Since sizes and thicknesses of the respective components are arbitrarily shown in the accompanying drawings for convenience of explanation, the present disclosure is not limited to contents shown in the accompanying drawings. In addition, thicknesses may be exaggerated in order to clearly represent several portions and regions.

In the following detailed description, the same components are classified into “first,” “second,” and the like, to differentiate names of components, and a sequence thereof is not necessarily limited thereto.

Throughout the specification, unless explicitly described to the contrary, the word “comprise” and variations such as “comprises” or “comprising,” will be understood to imply the inclusion of stated elements but not the exclusion of any other elements.

In addition, the terms “˜ unit”, “˜ means”, “˜ part”, “member”, etc., described in the specification mean units of a comprehensive configuration for performing at least one function and operation.

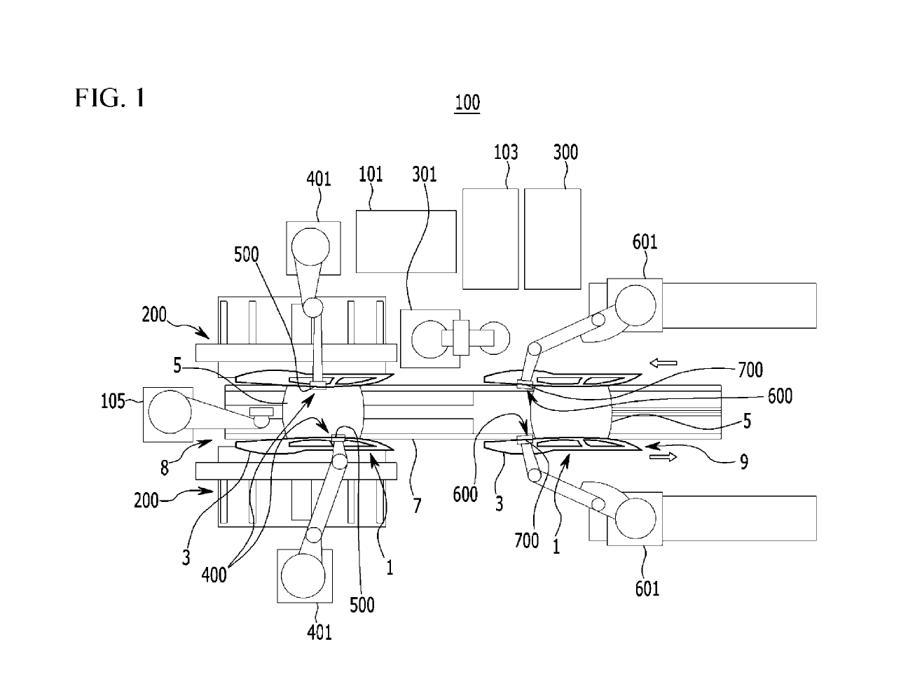

In FIG. 1, a roof laser-brazing system 100 may be applied to a main buck process of a vehicle body assembling line, for controlling and welding a main buck assembling part with a jig, and assembling a vehicle body.

Further, the roof laser-brazing system 100 may be applied to a process of bonding roof panel 5 to both side panels 3, based on a body 1 including both side panels 3, in the main buck process.

Here, the body 1 may have a structure in which both side panels 3 are assembled in a predetermined structure, and may have, for example, a structure in which the side panels 3 are assembled at both sides of the floor panel (not illustrated). The body 1 may be transferred along a transfer line 7 by a carriage (not illustrated).

In the art, a width direction of the body 1 is an L direction, a transfer direction of the body 1 is a T direction, and a height direction of the body 1 is an H direction. The exemplary forms of the present disclosure are not described based on an LTH direction but are described based on the width direction, the transfer direction, and the height direction of the body.

The roof laser-brazing system 100 has a structure in which a roof molding may be omitted by bonding portions of each of the side panels 3 of the body 1 to portions of roof panel 5 using a laser-brazing method.

The roof laser-brazing system 100 may be configured with a brazing section 8 and a grinding section 9 set along a transfer path of the body 1.

The roof laser-brazing system 100 has a structure in which the bonding portion of each of the side panels 3 of the body 1, and the bonding portions of roof panel 5, may be bonded to each other by a laser-brazing method.

The roof laser-brazing system 100 may be configured to grind brazing-beads of the bonding portions of both side panels 3 and the roof panel 5 in the grinding section 9.

The roof laser-brazing system 100 may basically include side panel fixed-positioning jigs 200, a roof pressing jig 300, brazing assemblies 400, gap measurement units 500, grinding assemblies 600, and bead checking units 700.

All the components as described above may be mounted on one process frame in a vehicle body assembling line of a main buck process and each of the components may also be mounted on each of the divided process frames.

The side panel fixed-positioning jigs 200 are each configured to control one of the side panels 3 of the body 1 to be fixedly positioned. The side panel fixed-positioning jigs 200 are configured in the brazing section 8, and are each mounted on opposite sides of the transfer path of the body 1.

The side panel fixed-positioning jigs 200 may each clamp one of the side panels 3 of the body 1 based on the body 1 of a predetermined vehicle model transferred to the brazing section 8 through the transfer path of the transfer line 7, and may fixedly position each of the side panels 3 at a position at which each of the side panels 3 is set.

The side panel fixed-positioning jigs 200 may correspond to different vehicle models of the body 1, and may each be configured to control one of the side panels 3 and to fixedly position one of the side panels 3 at predetermined positions based on gap measurement values between each of the side panels 3 and the roof panel 5, which are measured by the gap measurement unit 500 to be described below.

The “fixed position” as described above may be defined as a position to which one of the side panels 3 is moved in the width direction of the body 1 by one of the side panel fixed-positioning jigs 200 so that the gap between the side panel 3 and the roof panel 5 becomes zero.

The side panel fixed-positioning jigs 200 may each be configured to control one of the side panels 3, fixedly position one of the side panels 3 based on the gap measurement values measured by the gap measurement unit 500, and secure zero gaps between each of the side panels 3 and the roof panel 5. The above “control” may be defined as clamping one of the side panels 3.

The side panel fixed-positioning jigs 200 may be provided in pairs to be each mounted on both sides of the transfer path, having the transfer path of the body 1 disposed therebetween. However, only one side panel fixed-positioning jig 200, mounted on any one side of the transfer path, will be described below.

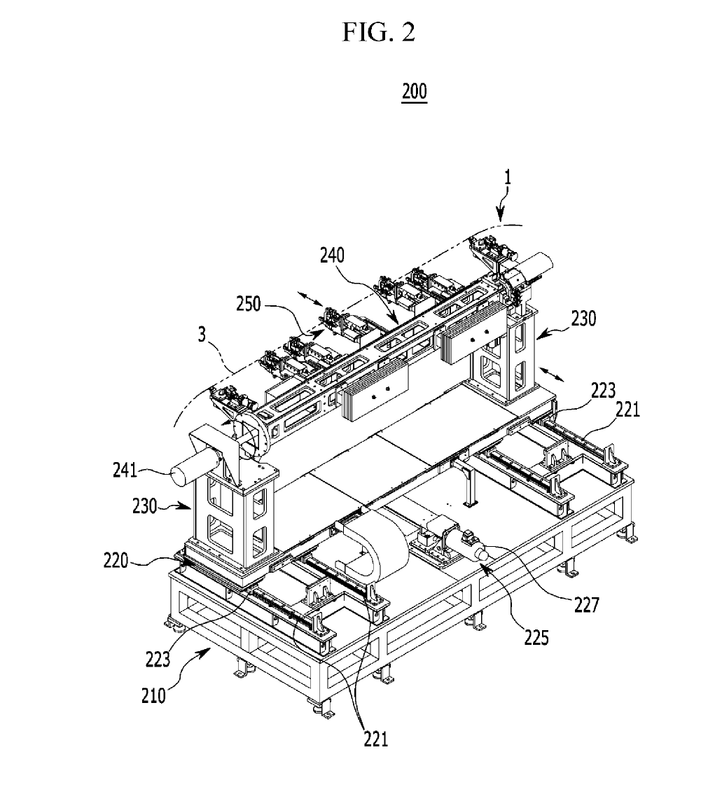

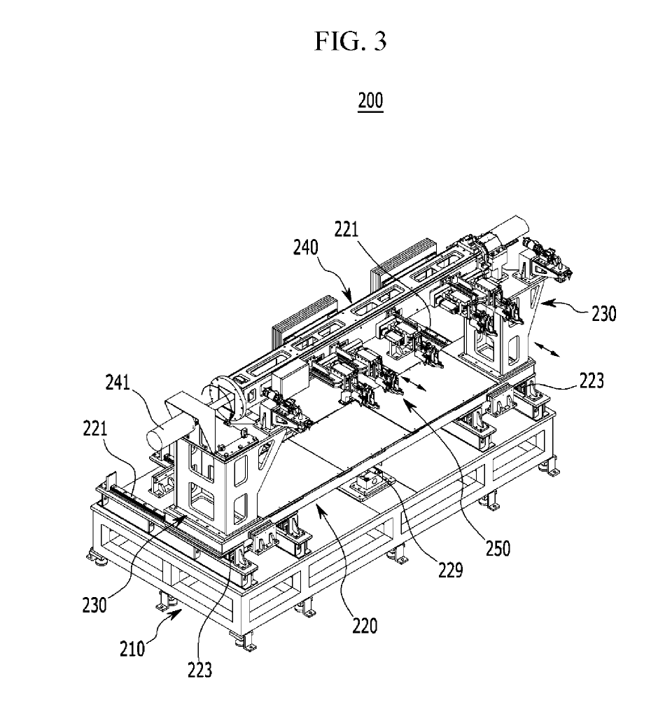

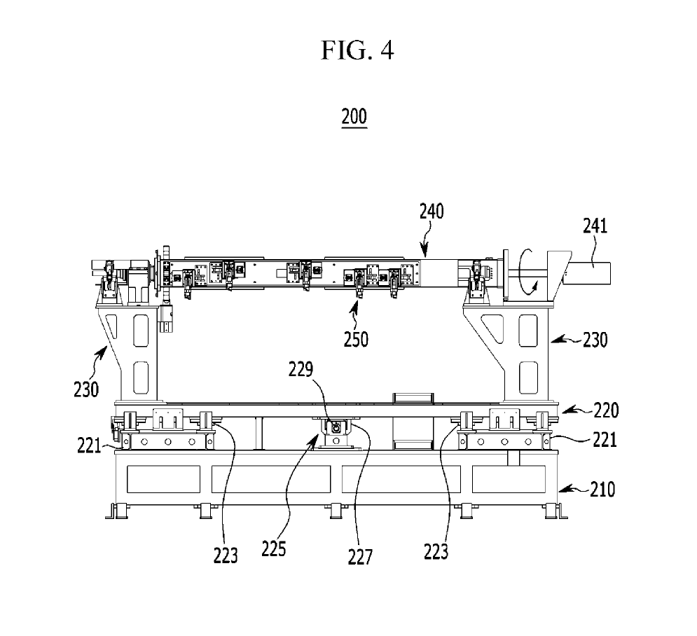

In FIGS. 2 to 4, a side panel fixed-positioning jig 200 may include a base frame 210, a moving frame 220, post frames 230, a support frame 240, and clampers 250.

The base frame 210 is configured to support the moving frame 220, the post frames 230, and the support frame 240, and is mounted on a side of the transfer path, having the transfer path of the body 1 disposed between base frame 210 and another base frame 210 in the brazing section 8.

The base frame 210 includes fittings such as various kinds of brackets, a support block, a plate, a housing, a cover, and a collar, for supporting the moving frames 220. The fittings are to mount the moving frame 220 at the base frame 210, and therefore except for an exceptional case, in an exemplary form of the present disclosure, the above-mentioned fittings are collectively referred to as the base frame 210.

As described above, the moving frame 220 is reciprocally mounted on the base frame 210 in the width direction of the body 1. The moving frame 220 is slidably mounted on a plurality of guide rails 221 which are mounted on the base frame 210.

The guide rails 221 are spaced apart from each other at a predetermined interval along the transfer direction of the body 1, mounted on an upper surface of the base frame 210, and extend in the width direction of the body 1. A lower surface of the moving frame 220 is provided with a slider 223. The slider 223 is slidably coupled with the guide rail 221.

The base frame 210 is provided with a first driving unit 225 configured to reciprocate the moving frame 220 in the width direction of the body 1. The first driving unit 225 is configured to transform a rotating motion of a motor into a linear motion of the moving frame 220.

The first driving unit 225 may include a first servo motor 227 mounted on the base frame 210, and a lead screw 229 connected to the first servo motor 227 and substantially threadedly-connected to the moving frame 220.

The first servo motor 227 may be fixedly mounted on an upper surface of the base frame 210. The lead screw 229 may be connected to a driving shaft of the first servo motor 227 and may be threadedly-connected to a predetermined block (not illustrated) fixed on a lower surface of the moving frame 220.

The post frames 230 are each installed at both sides of the moving frame 220 along the transfer direction of the body 1, and are fixedly mounted in a vertical direction of the moving frame 220.

The support frame 240 is configured to substantially support the clampers 250 to be described below, and extends along a length direction of one of the side panels 3, that is, along the transfer direction of the body 1, and is configured to be connected to the post frame 230.

The above-mentioned clampers 250 are configured to control one of the side panels 3, and to fixedly position one of the side panels 3 based on the gap measurement values measured by the gap measurement unit 500.

The clampers 250 are provided in plural, are mounted on the support frame 240 along the transfer direction of the body 1, and are reciprocally installed in the width direction of the body 1.

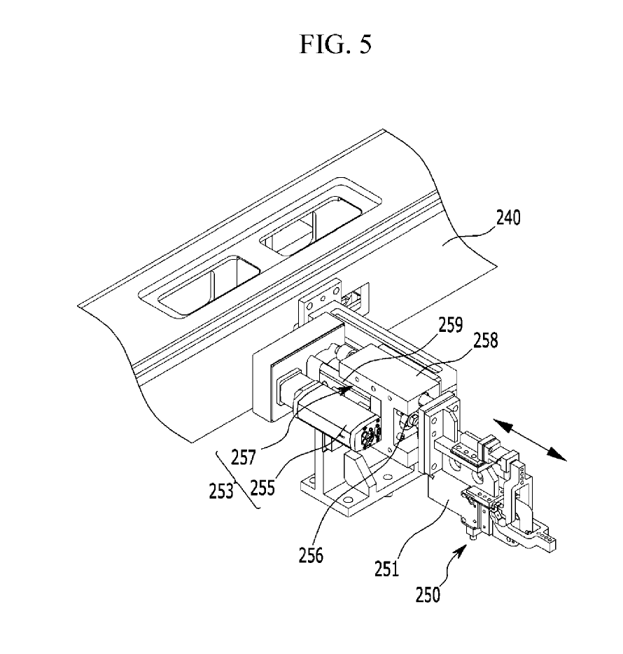

The clamper 250 is configured to control upper portions of one of the side panels 3, and as illustrated in FIG. 5, may be operated by a clamp cylinder 251, and may clamp the upper portions of one of the side panels 3. The clamper 250 may be a clamping apparatus well-known in the art, and therefore a more detailed description of a configuration thereof will be omitted in the present specification.

As described above, the clamper 250 is reciprocally mounted on the support frame 240 in the width direction of the body 1. To this end, the support frame 240 is provided with a second driving unit 253 configured to reciprocate the clamper 250 in the width direction of the body 1.

The second driving unit 253 may include a second servo motor 255 mounted on the support frame 240 and a linear motion (LM) guide 257 connected to the second servo motor 255 and fixing the clamper 250.

The second servo motor 255 is fixedly mounted on the support frame 240. The LM guide 257 is configured to receive a torque of the second servo motor 255 and to reciprocate the clamper 250 in the width direction of the body 1 by the torque.

The above-mentioned LM guide 257 may be connected to the second servo motor 255 through a power delivery means such as a belt and a gear. The LM guide 257 may include a ball screw 256 connected to the driving shaft of the second servo motor 255, a moving block 258 threadedly-connected to the ball screw 256 and connected to the clamper 250, and a rail member 259 slidably connected to the moving block 258.

The clamper 250 may linearly be reciprocated in the width direction of the body 1 through the above-mentioned LM guide 257 by rotating the second servo motor 255 forward and backward.

As described above, the clamper 250 is configured to be reciprocated in the width direction of the body 1 through the second driving unit 253 in order to move the one of the side panels 3 in the width direction of the body 1 while one of the side panels 3 is controlled by the clamper 250.

The clamper 250 is configured to move one of the side panels 3 in the width direction of the body 1 based on the gap measurement value measured by the gap measurement unit 500 when the clamper 250 controls the one of the side panels 3, and may set the gap between the side panel 3 and the roof panel 5 to be zero.

The moving frame 220 is configured to reciprocate in the width direction of the body 1 through the first driving unit 225 in order to move the clamper 250 to a preset position corresponding to the respective body 1 of different vehicle models.

The support frame 240 in which the clampers 250 are mounted may be rotatably mounted on the post frame 230 through the driving motor 241.

The support frame 240 may be rotatably supported by the post frame 230 and may be configured to rotate through the driving motor 241. The driving motor 241 may be fixedly mounted to the post frame 230 with the bracket.

The support frame 240 is rotatably configured in the post frame 230 through the driving motor 241 in order to allow for selective use of clampers 250 having different structures corresponding to the respective body 1 of different vehicle models depending on the vehicle model.

Here, the clampers 250 have different structures, corresponding to each vehicle model of the body 1, to control side panels 3 of different vehicle models, and may be installed at any one side of the support frame 240 or at least at the other side thereof.

Any one side of the support frame 240 may be provided along the transfer direction of the body 1 with clampers 250 corresponding to any one vehicle model, and the other side of the support frame 240 and another side may be provided along the transfer direction of the body 1 with clampers 250 corresponding to each of the different vehicle models.

The clampers 250 having different structures corresponding to the body 1 of different vehicle models are configured to be positioned at one of the side panels 3 of the corresponding vehicle model by rotating the support frame 240 through the driving motor 241.

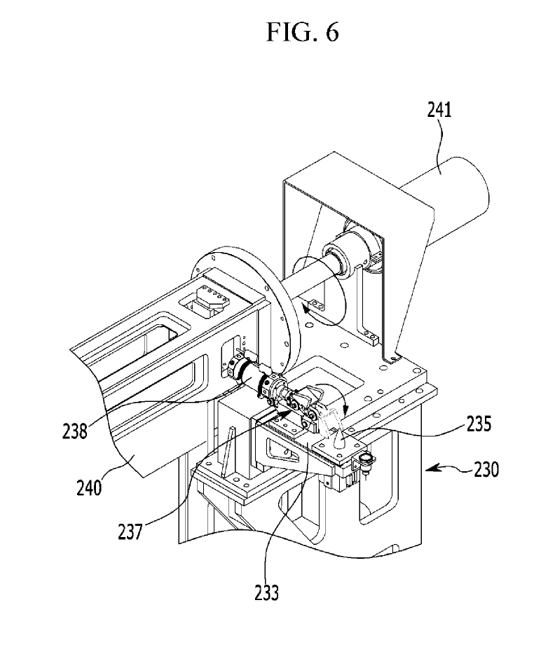

In FIG. 6, each post frame 230 is provided with a support bracket 233 for docking the roof pressing jig 300 (see FIG. 1) to be described below in more detail.

The support bracket 233 is provided with a fixed pin 235 coupled with the roof pressing jig 300 and configured to fix the roof pressing jig 300. The fixed pin 235 may be inserted into the docking portion of the roof pressing jig 300 for the support bracket 233.

The support bracket 233 of the post frame 230 is provided with a pin clamper 237 configured to control a pin coupling portion, that is, a docking portion of the roof pressing jig 300. The pin clamper 237 may be configured to hold the fixed pin 235 together with the pin coupling portion of the roof pressing jig 300 while the fixed pin 235 is coupled with the docking portion of the roof pressing jig 300.

The pin clamper 237 is configured to be rotated by the operation of a pin-clamping cylinder 238 and may hold the fixed pin 235 together with the pin coupling portion of the roof pressing jig 300 with an operating pressure of the pin clamping cylinder 238.

In FIG. 1, in an exemplary form of the present disclosure, the roof pressing jig 300 is configured to fixedly position the roof panel 5 loaded on both side panels 3 of the body 1, and to press the roof panels 5 with a handling robot 301. The roof pressing jig 300 may be detachably mounted on the handling robot 301 and may be docked in the side panel fixed-positioning jig 200 as described above.

The roof panel 5 may be unloaded from a roof alignment jig 101 by a roof loading jig 103 while it is aligned in the roof alignment jig 101, and may be loaded on both side panels 3 of the body 1.

The roof alignment jig 101 is configured to align the roof panel 5 at a preset position, and is mounted between the brazing section 8 and the grinding section 9. The roof loading jig 103 is detachably mounted on the handling robot 301 described above.

The above-mentioned roof alignment jig 101 includes a reference pin configured to hold a reference position of the roof panel 5, and retainers configured to support edge portions of the roof panel 5. The roof loading jig 103 includes the reference pin configured to hold the reference position of the roof panel 5, and the clampers configured to control the edge portions of the roof panel 5.

A more detailed configuration of the roof alignment jig 101 and the roof loading jig 103 is well-known in the art and therefore the detailed description of the configuration will be omitted in the present specification.

The handling robot 301 may be configured to change tools of the roof loading jig 103, the roof pressing jig 300, and a spot welding gun (not illustrated), using a tool changer.

Reference numeral 105, which was not yet explained in FIG. 1, is a welding robot provided with the spot welding gun, and is configured to spot-weld the roof panel 5 and front/rear roof rail parts, and is mounted in the brazing section 8.

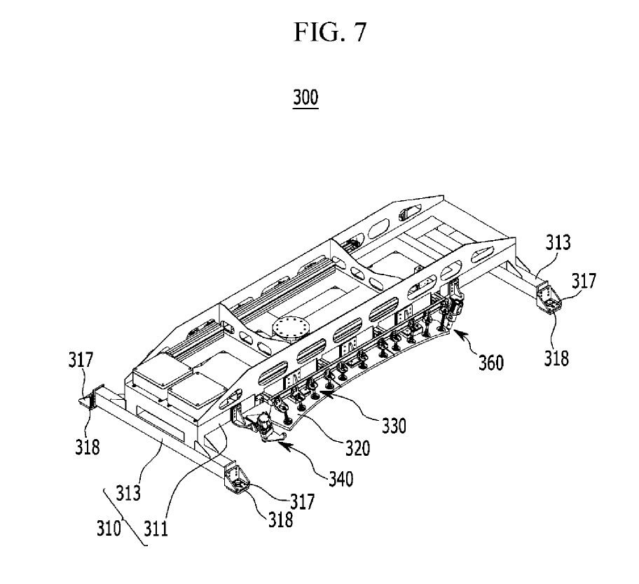

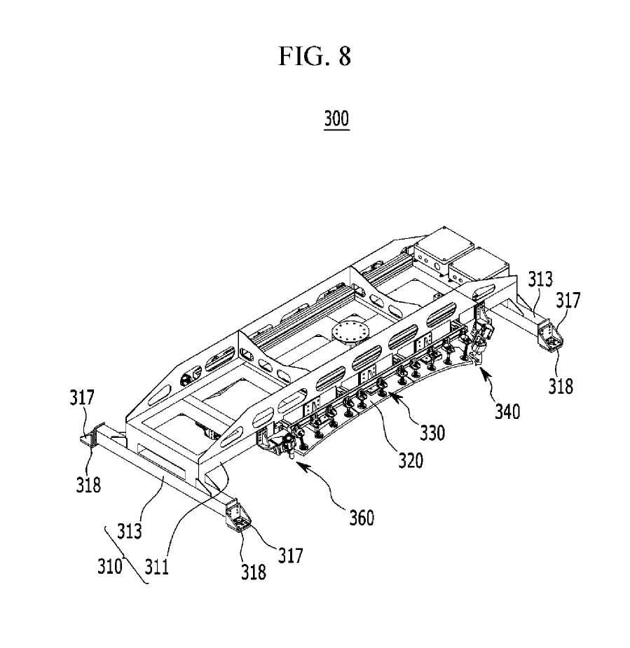

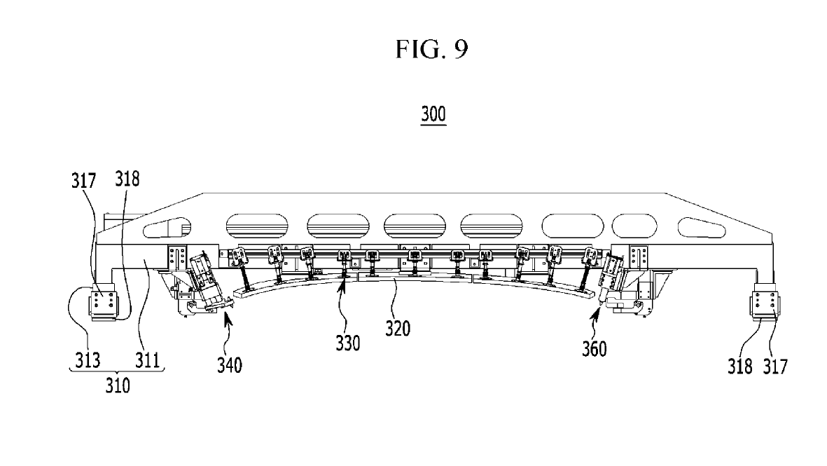

In FIGS. 7 to 9, the roof pressing jig 300 may include a jig frame 310, a control pad 320, vacuum cups 330, a control pin 340, and a reference pin 360.

The jig frame 310 is detachably mounted on a front tip of an arm of the handling robot 301. The jig frame 310 includes a main frame 311 and a sub frame 313 integrally connected to a front end and a rear end of a main frame 311.

The main frame 311 has a ladder shape and includes a robot coupling part 315 coupled with the front tip of the arm of the handling robot 301. The sub frame 313 has a linear shape and is disposed at the front end and the rear end of the main frame 311 along a horizontal direction (width direction of the body).

Both sides of each of the front end and the rear end of the jig frame 310, that is, both ends of each sub frame 313, are fixedly provided with docking brackets 317 which are docked in the support bracket 233 of the side panel fixed-positioning jig 200 as described above. A lower surface of the docking bracket 317 is provided with a rubber pad 318. The rubber pad 318 serves to buffer the shock of the docking bracket 317 applied to the support bracket 233, when the docking bracket 317 is docked in the support bracket 233.

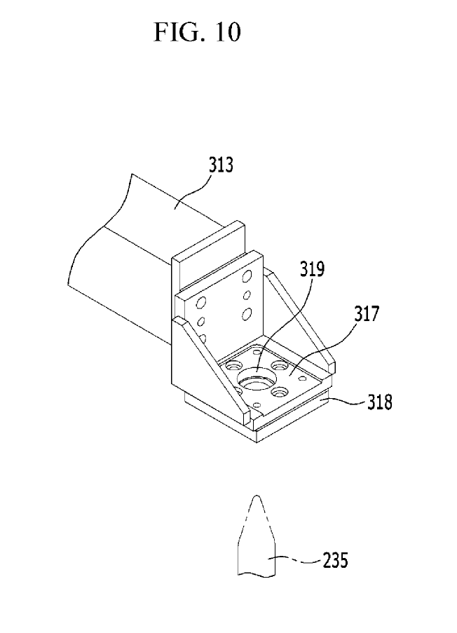

As illustrated in FIG. 10, the docking bracket 317 is provided with a pin hole 319 into which the fixed pin 235 of the side panel fixed-positioning jig 200 is configured to be inserted. That is, when the docking bracket 317 is docked in the support bracket 233 of the side panel fixed-positioning jig 200, the fixed pin 235 is coupled with the pin hole 319 of the docking bracket 317.

The “docking” may be defined as the state in which the docking bracket 317 is positioned in the support bracket 233, when the roof pressing jig 300 fixedly positions and presses the roof panel 5.

The control pad 320 is configured to support the roof panel 5 loaded on both side panels 3 of the body 1, and to support both side edge portions of the roof panel 5 along a length direction of both side panels 3.

The control pad 320 is fixedly mounted on left and right sides of the main frame 311, respectively, in the jig frame and is disposed along a length direction of the main frame 311. The control pad 320 has a shape corresponding to the roof panel 5.

The control pad 320 is made of an aluminum material having excellent heat conductivity to prevent both side panels 3 and the roof panel 5 from overheating when they are bonded by laser-brazing to each other.

The vacuum cups 330 are configured to vacuum-adhere to a skin surface of both side edge portions of the roof panel 5, and are mounted on the main frame 311 of the jig frame 310 corresponding to the control pad 320.

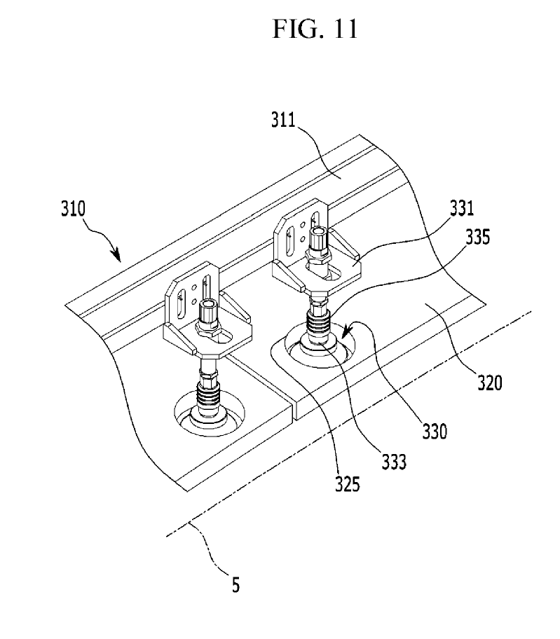

As illustrated in FIG. 11, the vacuum cups 330 may be configured to penetrate through a plurality of through holes 325 continuously formed in the control pad 320 along both side edge portions of the roof panel 5 to vacuum-adhere to the skin surface of both side edge portions of the roof panel 5.

The vacuum cups 330 are mounted on the main frame 311 of the jig frame 310 and continuously spaced apart from each other along the length direction of the main frame 311, and are mounted through the fixed bracket 331 fixed to the main frame 311.

Here, the fixed bracket 331 is fixedly provided with a mounting rod 333. An upper end of the mounting rod 333 is fixed to the fixed bracket 331 and a lower end of the mounting rod 333 is disposed in the through hole 325 of the control pad 320. The lower end of the mounting rod 333 is provided with the vacuum cup 330. The vacuum cup 330 may be connected to the lower end of the mounting rod 333 through a spring 335.

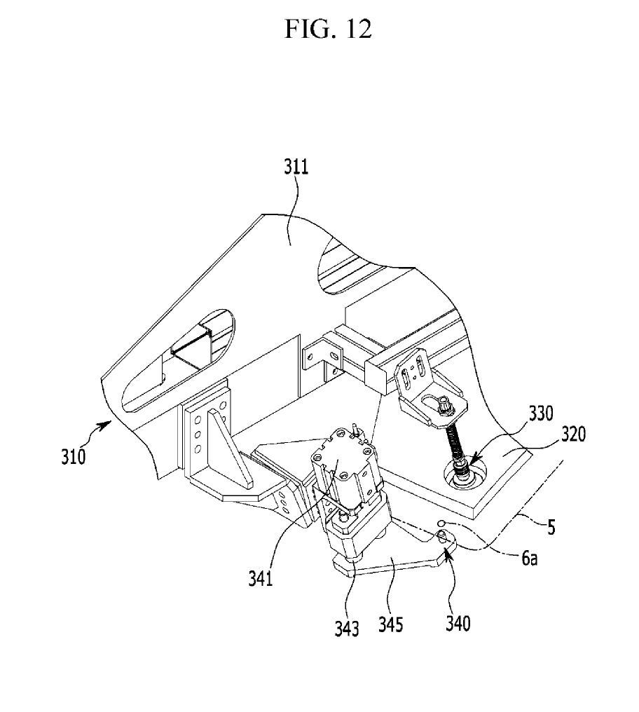

When the control pin 340 controls the roof panel 5 with the control pad 320 and the vacuum cups 330, as illustrated in FIG. 12, the control pin 340 is downwardly inserted into the control hole 6a provided in the roof panel 5 from above in order to control the roof panel 5. The control pin 340 is movably mounted in a vertical direction at the main frame 311 of the jig frame 310 at the front end of the control pad 320.

As such, the jig frame 310 is provided with a control pin cylinder 341 configured to reciprocate the control pin 340 in a vertical direction. The control pin cylinder 341 is connected to the control pin 340 and is fixedly mounted on the main frame 311 of the jig frame 310.

The control pin cylinder 341 includes a control pin operating rod 343 configured to be operated forward and backward by an air pressure or an oil pressure. The control pin operating rod 343 is provided with a control bracket 345 configured to support the lower surface of the roof panel 5 and fix the control pin 340. The control bracket 345 forms a flat upper surface. The control pin 340 is fixedly mounted on an upper surface of the control bracket 345.

In an exemplary form of the present disclosure, if the control pin operating rod 343 of the control pin cylinder 341 is operated upward from the state in which it had operated downward, the control pin 340 may be inserted into the control hole 6a of the roof panel 5 simultaneously with the control bracket 345 supporting the lower surface of the roof panel 5, in order to control the roof panel 5.

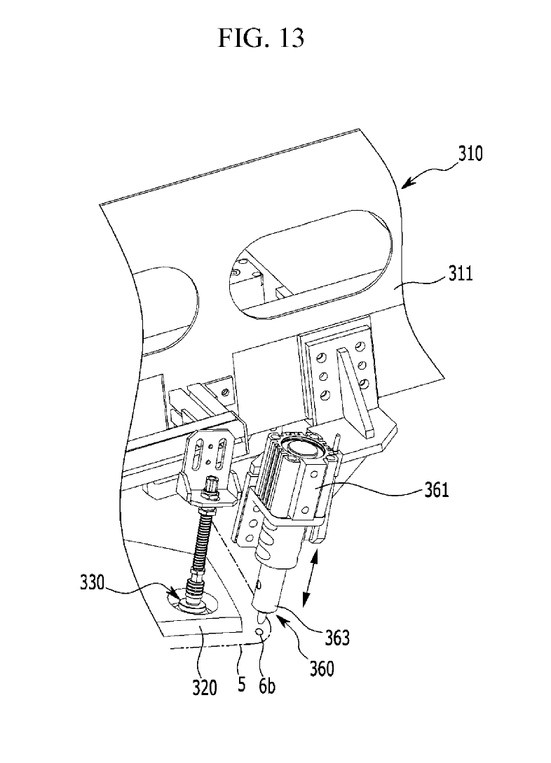

When the reference pin 360 controls the roof panel 5 using the control pad 320, the vacuum cups 330, and the control pin 340, as illustrated in FIG. 13, the reference pin 360 is inserted downward from above into a reference hole 6b mounted on the roof panel 5. The reference pin 360 is movably mounted in a vertical direction at the main frame 311 of the jig frame 310 at the rear end of the control pad 320.

The jig frame 310 is provided with a reference pin cylinder 361 configured to reciprocate the reference pin 360 in a vertical direction. The reference pin cylinder 361 is connected to the reference pin 360 and is fixedly mounted on the main frame 311 of the jig frame 310.

The reference pin cylinder 361 includes a reference pin operating rod 363 configured to be operated forward and backward by the air pressure or the oil pressure. The reference pin operating rod 363 is provided with the reference pin 360.

In an exemplary form of the present disclosure, when the roof panel 5 is controlled by the control pad 320, the vacuum cups 330, and the control pin 340, if the reference pin operating rod 363 of the reference pin cylinder 361 is operated downward from the state in which it had operated in an upward direction, the reference pin 360 is inserted into the reference hole 6b of the roof panel 5 and holds the reference position of the roof panel 5.

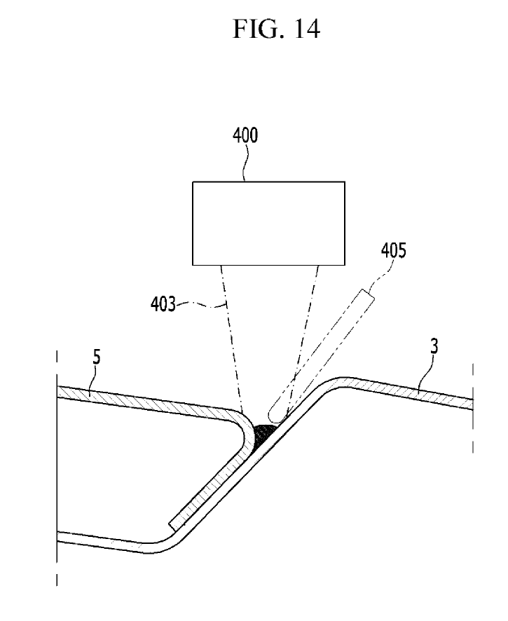

In FIGS. 1 and 14, in an exemplary form of the present disclosure, each brazing assembly 400 is configured to bond, by brazing, the bonding portions of one of the side panels 3 and of the roof panel 5 which are pressed and adhered to each other by the roof pressing jig 300, by using a laser as the heat source.

Each brazing assembly 400 is mounted on one of a pair of brazing robots 401 at the side panel fixed-positioning jig 200 of the brazing section 8. The brazing robots 401 are mounted on the side panel fixed-positioning jigs 200, respectively, having the transfer path of the body 1 disposed therebetween.

Here, the brazing assembly 400 may be configured to melt a filler metal using the laser as the heat source and to bond, by brazing, the bonding portions of one of the side panels 3 and the roof panel 5.

For example, the brazing assembly 400 is configured to emit a continuous wave Nd:YAG laser beam 403 oscillated by the laser oscillator to irradiate the bonding portions of one of the side panels 3 and the roof panel 5 to melt a filter wire 405 which is the filler metal, thereby bonding, by brazing, the bonding portions of one of the side panels 3 and the roof panel 5.

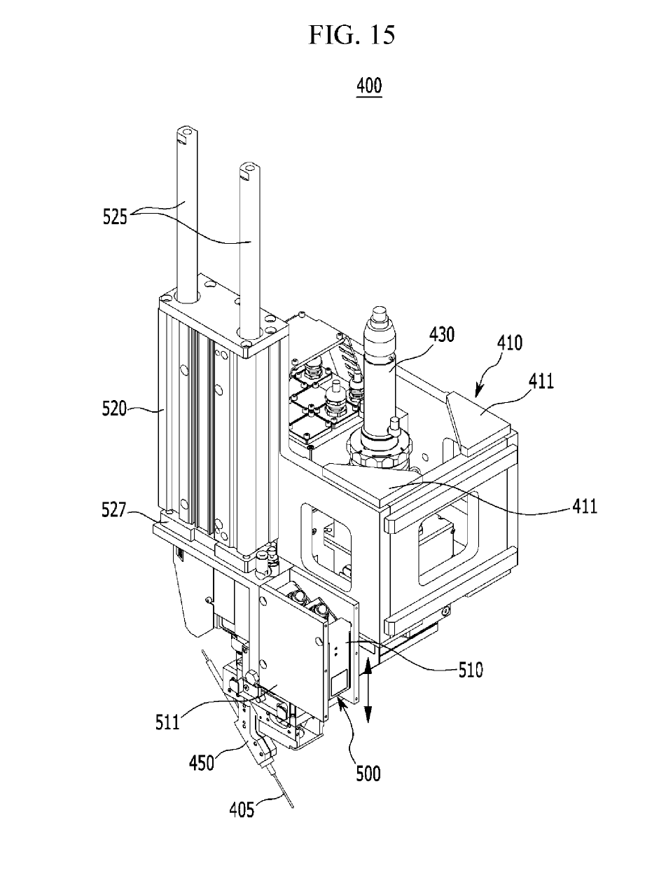

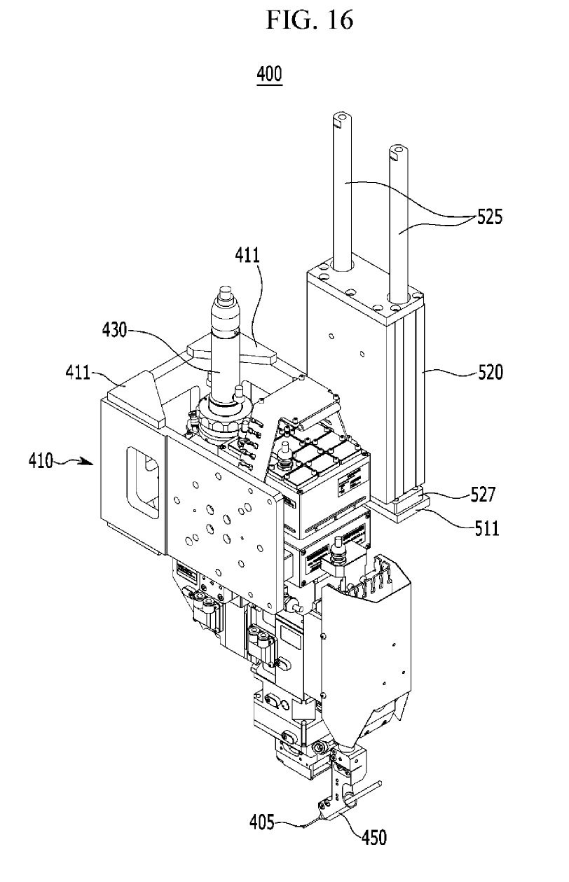

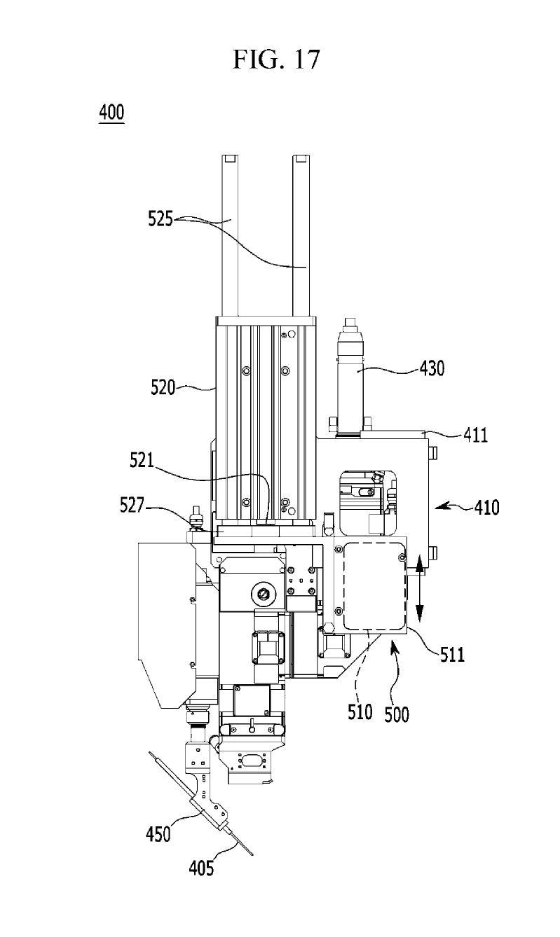

In FIGS. 15 to 17, the brazing assembly 400 includes a brazing bracket 410, a laser head 430, and a wire feeder 450.

The brazing bracket 410 is mounted on the front tip of the arm of the brazing robot 401. The brazing bracket 410 is rotatably held by the brazing robot 401 and may be transferred along the bonded portions of one of the side panels 3 and the roof panel 5 by the brazing robot 401.

The brazing bracket 410 is directly mounted on the arm of the brazing robot 401, taking into consideration the characteristics of the laser head 430 which is sensitive to external environment such as vibration. The brazing bracket 410 has approximately a U-shape, and includes the reinforcing plate 411 provided at the corner portions thereof to reduce the weakness of the corner portion.

The laser head 430 is configured to irradiate the laser beam to the bonding portions of one of the side panels 3 and the roof panel 5, and is mounted on the brazing bracket 410. The laser head 430 is provided as an Nd:YAG optic head configured to emit the continuous wave Nd:YAG laser beam from a laser oscillator controlled by a controller 5 to irradiate along the bonded portions of one of the side panels 3 and the roof panel 5

Here, the laser oscillated from the laser oscillator may be configured to irradiate the bonding portions of one of the side panels 3 and the roof panel 5 from the laser head 430, while being focused by the optical system.

The wire feeder 450 is configured to supply the filler wire 405, which is the filler metal, to the focal position of the laser beam emitted from the laser head 430. The wire feeder 450 is mounted on the brazing bracket 410.

The laser head 430 and the wire feeder 450 are configured as a laser optic head apparatus and a wire feeding apparatus which are well-known in the art and therefore more detailed description of the configuration will be omitted in the present specification.

In FIGS. 1 and 15 to 17, the gap measurement units 500 are configured to measure the matching gaps between the roof panel 5 and each of the side panels 3 which are pressed by the roof pressing jig 300 before both side panels 3 and the roof panel 5 are bonded, by laser-brazing, to each other using the laser head 430 and the wire feeder 450 of the brazing assembly 400.

A gap measurement unit 500 is configured to measure a matching gap between the roof panel 5 and one of the side panels 3 which are pressed by the roof pressing jig 300, and to output the measured values to the controller (not illustrated).

Here, the controller may be configured to control the operation of the side panel fixed-positioning jig 200 based on the matching gap measurement value between the roof panel 5 and one of the side panels 3, which is measured by the gap measurement unit 500.

For example, the controller may be configured to apply a control signal to the second driving unit 253 of the side panel fixed-positioning jig 200 based on the gap measurement value of the roof panel 5 and one of the side panels 3 which is measured by the gap measurement unit 500, and to thereby move the clampers 250 of the side panel fixed-positioning jig 200 controlling one of the side panels 3 in the width direction of the body 1.

In an exemplary form of the present disclosure, based on the gap measurement value of the roof panel 5 and one of the side panels 3 measured by the gap measurement unit 500, one of the side panels 3 may be moved and fixedly positioned in the width direction of the body 1 by the side panel fixed-positioning jig 200, and the gaps between one of the side panels 3 and the roof panel 5 may be set to zero.

The gap measurement unit 500 is mounted on the brazing bracket 410 of the brazing assembly 400. The gap measurement unit 500 includes a first profile sensor 510 configured to scan matching portions between one of the side panels 3 and the roof panel 5, and to measure the gap between the matching portions.

The first profile sensor 510 is configured to scan the matching portions between one of the side panels 3 and the roof panel 5 using the laser slit to measure the gap between the matching portions. For example, the first profile sensor 510 is configured to set a virtual reference line based on a straight portion of the roof panel 5 and to calculate an interval between the profiles generated on the reference line to measure the matching gaps between the roof panel 5 and one of the side panels 3.

The profile sensor is well-known in the art and therefore the description of the more detailed configuration of the profile sensor will be omitted in the present specification.

Here, the first profile sensor 510 is mounted on the brazing bracket 410 of the brazing assembly 400 side by a sensor bracket 511. Further, the sensor bracket 511 fixes the first profile sensor 510 and is mounted to move forward and backward with respect to the brazing bracket 410.

For this purpose, the brazing bracket 410 is fixedly mounted with the operating cylinder 520. The operating cylinder 520 includes an operating rod 521 configured to be operated forward and backward by an air pressure or an oil pressure. A front tip of the operating rod 521 is connectably provided with sensor bracket 511 to which the first profile sensor 510 is fixed. Therefore, the sensor bracket 511 may be moved forward and backward by the operating cylinder 520.

Further, the operating cylinder 520 is provided with a pair of guide bars 525 configured to guide the sensor bracket 511 when being moved forward and backward by the operating rod 521. The guide bar 525 is slidably inserted into the body of the operating cylinder 520 and is coupled with a front end of the operating rod 521 through the fixed block 527. The fixed block 527 connects the front end of the operating rod 521 to a front end of the guide bar 525 (lower end in the drawing) and is fixed to the sensor bracket 511.

The sensor bracket 511 may be configured to be moved forward by the operating cylinder 520 to measure the matching gap between the roof panel 5 and one of the side panels 3 using the first profile sensor 510, before one of the side panels 3 and the roof panel 5 are bonded, by laser-brazing, to each other by the brazing assembly 400.

The sensor bracket 511 is configured to be moved backward by the operating cylinder 520 and may thus be configured to avoid interference with the brazing assembly 400, when one of the side panels 3 and the roof panel 5 are bonded, by laser-brazing, to each other by the brazing assembly 400

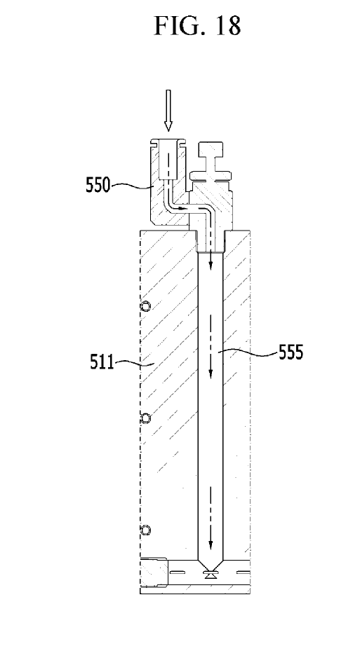

As illustrated in FIG. 18, the sensor bracket 511 is provided with an air blower 550 configured to inject air onto the brazing bonding portions of one of the side panels 3 and the roof panel 5 when one of the side panels 3 and the roof panels 5 are bonded, by laser-brazing, to each other by the brazing assembly 400.

That is, the air blower 550 is configured to inject air onto the brazing bonding portions of one of the side panels 3 and the roof panel 5 and to thereby prevent foreign materials from being attached to the laser-brazing bonding portions of one of the side panels 3 and the roof panel 5.

The air blower 550 may be supplied with a predetermined pressure of air supplied through an air compressor (not illustrated) and may be configured to inject the air to the brazing bonding portions of one of the side panels 3 and the roof panel 5.

For example, the air blower 550 may be configured to inject air in a vertical direction to the irradiation direction of the laser beam emitted from the laser head 430 of the brazing assembly 400.

To this end, the sensor bracket 511 is provided with an air injection path 555 connected to the air blower 550. The air injection path 555 is formed along the irradiation direction of the laser beam emitted from the laser head 430, and is provided as a path opened in the vertical direction to the irradiation direction of the laser beam. Here, the air injection path 555 is formed in the sensor bracket 511 along the vertical direction and may be configured to inject air through the lower end thereof.

In FIG. 1, each grinding assembly 600 is configured to grind a brazing-bead (not illustrated) of the laser-brazing bonding portions of one of the side panels 3 and the roof panel 5 bonded by the brazing assembly 400.

A grinding assembly 600 may be configured to grind the brazing-bead after both side panels 3 and the roof panel 5 have been bonded, by laser-brazing, by the brazing assembly 400 in the brazing section 8 of the body transfer path, and the body 1 has been transferred to the grinding section 9 along the body transfer path.

Here, each grinding assembly 600 is configured in one of a pair of grinding robots 601 in the grinding section 9 of the body transfer path. The grinding robots 601 are installed at both sides, having the transfer path of the body 1 disposed therebetween.

In this case, the grinding assembly 600 may move along a predetermined teaching path by the grinding robot 601 to grind the brazing-beads of the bonded portions of one of the side panels 3 and the roof panel 5.

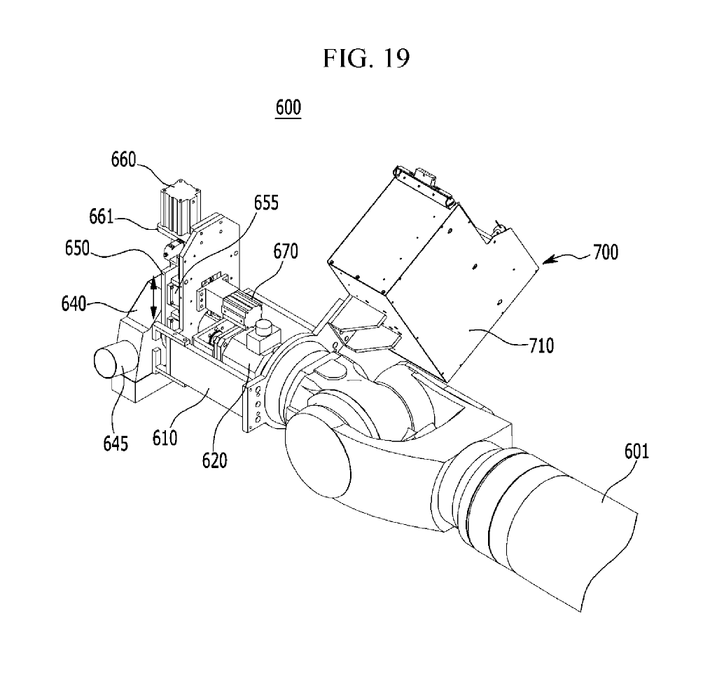

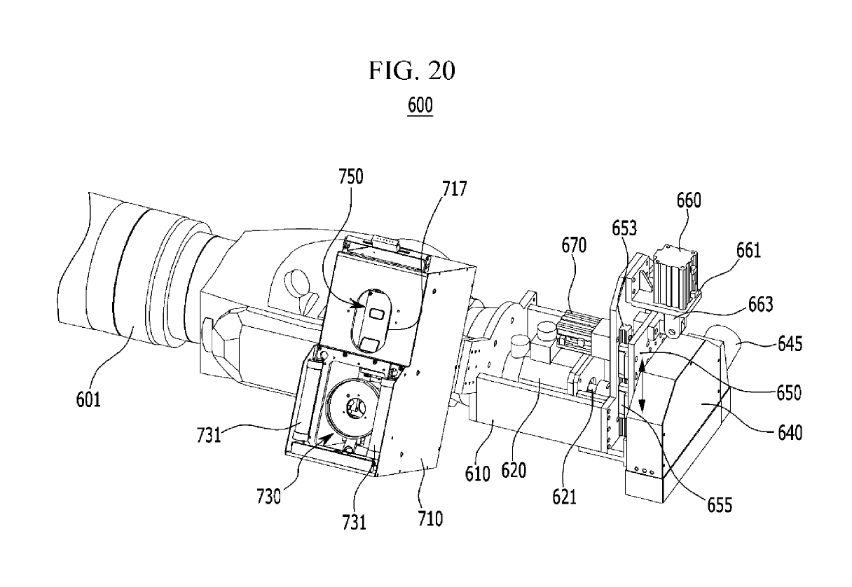

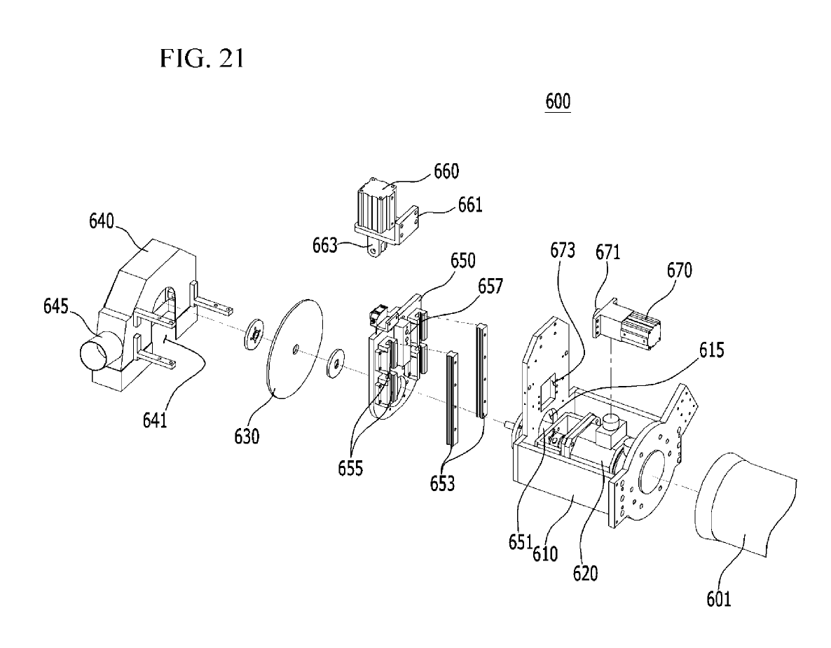

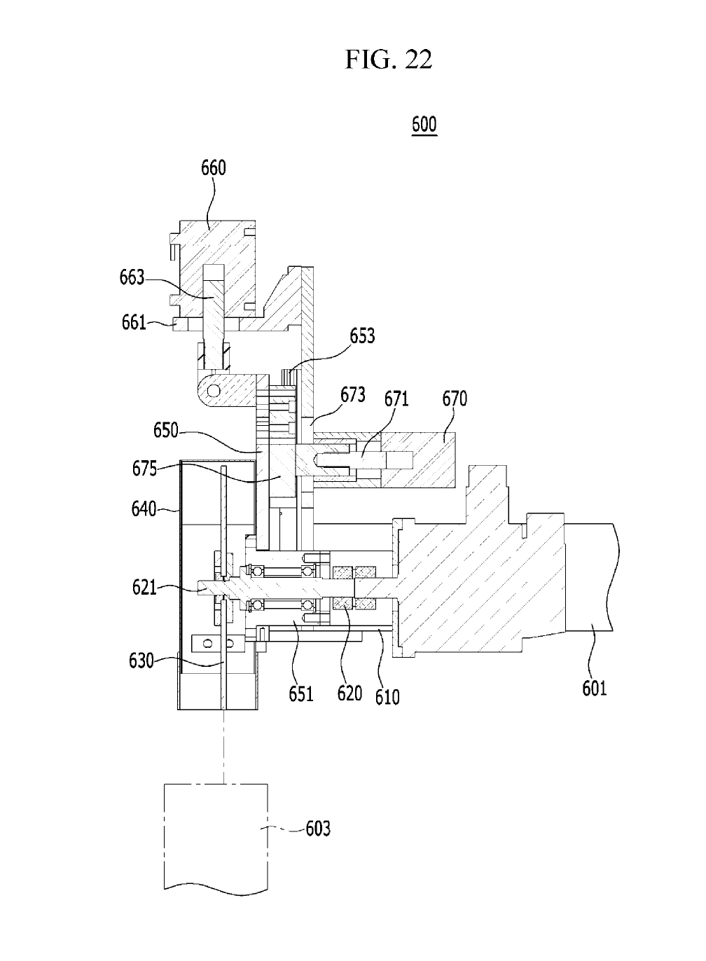

In FIGS. 1 and 19 to 22, the grinding assembly 600 may include a grinding bracket 610, a grinding motor 620, a grinding wheel 630, a wheel cover 640, a moving plate 650, a pressure control cylinder 660, and a stopper cylinder 670.

The grinding bracket 610 may be mounted at a tip of an arm of the grinding robot 601, may be rotatably held by the grinding robot 601, and may be transferred along the bonding portions of one of the side panels 3 and the roof panel 5 by the grinding robot 601.

The grinding motor 620 is configured to rotate the grinding wheel 630 (to be described below), and may be movably mounted in a vertical direction at the grinding bracket 610 with respect to the drawings.

The grinding wheel 630 is configured to grind the brazing-beads of the bonding portions of one of the side panels 3 and the roof panel 5 which are bonded, by laser-brazing, to each other. The grinding wheel 630 has a disc shape and may be configured to rotate while being coupled with the driving shaft 621 of the grinding motor 620.

The wheel cover 640 is configured to cover the grinding wheel 630 and to collect grinding dust, scattered at the time of grinding the brazing-beads of the bonding portions of one of the side panels 3 and the roof panel 5 by the grinding wheel 630, without hindering the vertical movement of the grinding motor 620.

The wheel cover 640 is provided as a housing, the lower end of which is opened, while otherwise enclosing the whole of the grinding wheel 630 coupled with the driving shaft 621 of the grinding motor 620, and is fixedly mounted at the grinding bracket 610.

Here, the grinding wheel 630 is configured to be rotated inside the wheel cover 640 by the grinding motor 620, and may be configured to grind the brazing-bead through the lower open end of the wheel cover 640.

The wheel cover 640 is provided with a first guide groove 641 configured to guide the vertical movement of the grinding motor 620 while not hindering the vertical movement of the grinding motor 620. The first guide groove 641 is formed on one surface of the wheel cover 640 fixed to the grinding bracket 610, and extends upward from the lower open end of the wheel cover 640.

The wheel cover 640 is provided with an inlet 645 for sucking grinding dust scattered at the time of grinding the brazing-beads of the bonding portions of one of the side panels 3 and the roof panel 5 by the grinding wheel 630.

The inlet 645 is configured to suck the grinding dust scattered in the wheel cover 640 and to expel the grinding dust to the outside of the wheel cover 640, and may be connected to a vacuum pump (not illustrated) through, for example, a dust exhaust line (not illustrated).

The moving plate 650 supports the grinding motor 620 to the grinding bracket 610, and guides the vertical movement of the grinding motor 620, and is disposed between the grinding bracket 610 and the wheel cover 640.

The moving plate 650 is connected to the driving shaft 621 of the grinding motor 620 through a bushing 651 and mounted at the grinding bracket 610 to be movable in a vertical direction.

The bushing 651 is mounted on the driving shaft 621 of the grinding motor 620 and rotatably supports the driving shaft 621, and is mounted as a rotating support having a cylinder shape.

For the vertical movement of the moving plate 650 as described above, one surface of the grinding bracket 610 corresponding to the moving plate 650 is provided with a pair of rail blocks 653. One surface of the moving plate 650 corresponding to the rail block 653 is provided with a pair of sliding blocks 655 slidably coupled with the rail block 653.

Here, the grinding motor 620 is connected to the moving plate 650 through the bushing 651 on the driving shaft 621 and therefore may be configured to be moved in a vertical direction with respect to the grinding bracket 610 through the rail block 653 and the sliding block 655.

That is, the grinding motor 620 may be configured to be moved downward under its own weight, and to be moved upward by a predetermined external force, and the lowermost moving position of the grinding motor 620 and the uppermost moving position thereof may be determined by a separate stopper, for example, a stopper (protrusion, etc.) provided at upper and lower ends of the rail block 653.

The grinding bracket 610 is provided with a second guide groove 615 configured to guide the bushing 651 in a vertical direction and not to hinder the vertical movement of the grinding motor 620.

The second guide groove 615 may extend upward from the lower end at one surface of the grinding bracket 610 corresponding to the moving plate 650, and may be configured to vertically guide the bushing 651 on the driving shaft 621 of the grinding motor 620.

The pressure control cylinder 660 is configured to control a grinding pressure of the grinding wheel 630 applied to the brazing-beads of the bonding portions of one of the side panels 3 and the roof panel 5.

The pressure control cylinder 660 is fixedly mounted at the grinding bracket 610 and is configured to be connected to the moving plate 650. The pressure control cylinder 660 may be fixedly mounted at the upper end of the grinding bracket 610 through a mounting bracket 661, and may be connected to the moving plate 650 through a pressure control rod 663.

The pressure control cylinder 660 is a proportional pressure controller which may be configured to a control a pressure to be a pressure of 0 to 10 bars, and may be configured to apply a predetermined air pressure to the pressure control rod 663 based on a voltage and a current, in order to control the grinding pressure of the grinding wheel 630 applied to the brazing-beads.

The stopper cylinder 670 is configured to selectively limit the vertical movement of the moving plate 650 and is fixedly mounted at the grinding bracket 610. That is, the stopper cylinder 670 is configured to limit the vertical movement from its own weight and from the external force of the grinding motor 620 as described above.

The stopper cylinder 670 includes a stopper operating rod 671 which penetrates through the grinding bracket 610 and is configured to be operated forward and backward toward the moving plate 650. Therefore, the grinding bracket 610 is provided with a through hole 673 through which the stopper operating rod 671 penetrates at the portion where the stopper cylinder 670 is fixedly mounted.

Further, one surface of the moving plate 650 corresponding to the front end of the stopper operating rod 671 is provided with a friction pad 675. The friction pad 675 may adhere to the front end of the stopper operating rod 671 to limit the vertical movement from its own weight and from the external force of the grinding motor 620. The friction pad 675 may be made of a rubber material of, for example, a Teflon material.

Movement of grinding motor 620 in a vertical direction by its own weight and by the external force on the grinding motor 620 is configured to be limited by the stopper cylinder 670 in order to take into consideration the abrasion of the grinding wheel 630 that occurs due to grinding the brazing-beads with the grinding wheel 630.

In other words, since the grinding assembly 600 is moved along the predetermined taught path by the grinding robot 601, and grinds the brazing-beads with the grinding wheel 630, the grinding surface of the grinding wheel 630 needs to always grind the brazing-beads at the preset position.

However, when the grinding wheel 630 is newly mounted in the grounding motor 620, the grinding surface of the grinding wheel 630 is positioned below the reference position, based on the position of the brazing-bead.

In this case, according to an exemplary form of the present disclosure, the separate support means 603 is configured to apply the external force to the grinding wheel 630 to move upwardly the grinding motor 620 together with the grinding wheel 630 through the moving plate 650, and to position the grinding surface of the grinding wheel 630 at the preset position. Further, the movement of the grinding motor 620 may be limited by the stopper cylinder 670, and the grinding surface of the grinding wheel 630 may be fixed at the preset position.

In contrast, when the grinding wheel 630 is worn as the brazing-beads are ground by the grinding wheel 630, the grinding surface of the grinding wheel 630 is positioned above the reference position, based on the position of the brazing-bead.

According to an exemplary form of the present disclosure, if the limitation on movement of the grinding motor 620 is released by the stopper cylinder 670, the grinding motor 620 moves downwardly together with the grinding wheel 630 under its own weight, and the grinding surface of the grinding wheel 630 is positioned at the preset position by the support means 603. Further, the movement of the grinding motor 620 may be limited by the stopper cylinder 670 and the grinding surface of the grinding wheel 630 may be fixed at the preset position.

The stopper cylinder 670 may be configured to be operated by a position sensor (not illustrated) configured to sense the grinding surface, based on the preset position of the grinding surface for the grinding wheel 630.

In FIGS. 1 and 19 to 22, in to an exemplary form of the present disclosure, each bead checking unit 700 is configured to check the brazing-bead ground by a grinding assembly 600. That is, the bead checking unit 700 is configured to automatically detect defects of the brazing-bead ground by the grinding assembly 600.

The bead checking unit 700 is mounted on the grinding assembly 600 and may be transferred along the ground brazing-beads of the bonding portions of one of the side panels 3 and the roof panel 5 by the grinding robot 601.

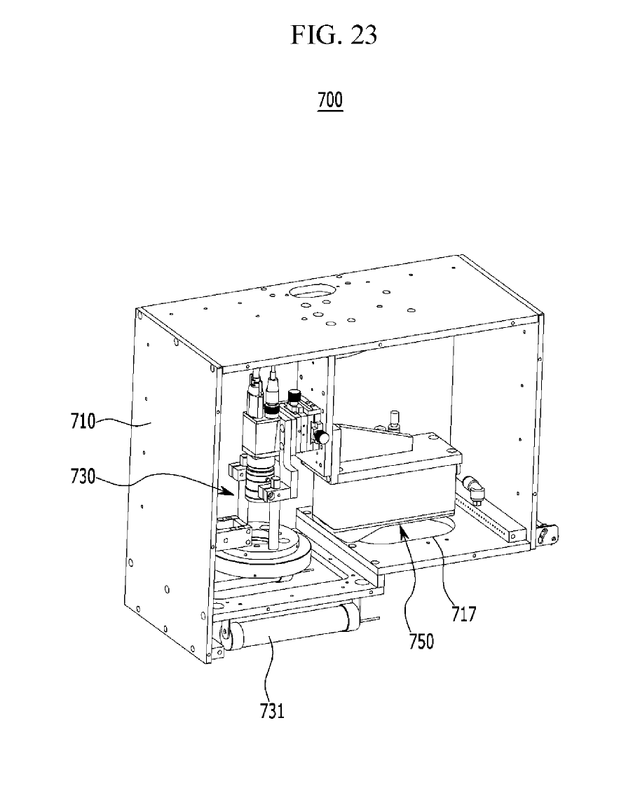

As illustrated in FIG. 23, the bead checking unit 700 includes a mounting bracket 710, a vision camera 730, and a second profile sensor 750.

The mounting bracket 710 is fixedly mounted to the grounding bracket 610 of the grinding assembly 600. The mounting bracket 710 may be rotated together with the grinding bracket 610 by the grinding robot 601.

The vision camera 730 is configured to vision-photograph the ground brazing-bead and to output the vision data to the controller as described above, and is fixedly mounted on the mounting bracket 710.

The mounting bracket 710 is provided with an illumination unit 731 configured to emit illumination light irradiating the ground brazing-bead. The illuminating unit 731 is fixedly mounted on the mounting bracket 710 in the vision photographing region of the vision camera 730.

The controller is configured to analyze the vision data received from the vision camera 730 to calculate a width of the ground brazing-bead, etc., and to compare the calculated value with the reference value (reference value of the ground brazing-bead) to detect the defects of the ground brazing-bead.

Meanwhile, the vision camera 730 may be configured to vision-photograph the predetermined reference point of the body 1, for example, a brazing portion of a front glass mounting hole and a center filler side, before a grinding of the brazing-bead by the grinding assembly 600, and to output the vision data to the controller. That is, the vision camera 730 may be configured to sense the position of the body 1 before the brazing-bead is ground by the grinding assembly 600.

The controller may be configured to analyze the vision data received from the vision camera 730 to calculate the position value of the body 1 and to compare the calculated value with the reference value (reference position value of the body) to correct the grinding position of the grinding assembly 600.

The second profile sensor 750 is configured to scan the ground brazing-bead to measure the height of the brazing-bead, etc., and is fixedly mounted on the mounting bracket 710 together with the vision camera 730.

The second profile sensor 750 may be configured to scan the ground brazing-bead using the laser slit and to measure the height of the brazing-bead, etc. For example, the second profile sensor 750 is configured to sense the cross section of the ground brazing-bead in a two-dimensional profile form and output the detection signal to the controller.

The controller may be configured to analyze the detection signal received from the second profile sensor 750 to calculate the height of the ground brazing-bead, etc., and to compare the calculated value with the reference value (reference value of the ground brazing-bead) to detect the defects of the ground brazing-bead.

The profile sensor is well-known in the art and therefore the description of the more detailed configuration of the profile sensor will be omitted in the present specification.

Here, the mounting bracket 710 is provided with a beam passing hole 717 through which a scan beam (laser slit) emitted from the second profile sensor 750 passes.

Hereinafter, operation of the roof laser-brazing system according to an exemplary form of the present disclosure configured as described above will be described in detail with reference to the drawings described above.

First, the body 1, in which both side panels 3 are assembled in the predetermined structure, is transferred to the side panel fixed-positioning jigs 200 of the brazing section 8 along the transfer line 7 through the carriage (not illustrated) in the main buck process of the vehicle body assembling line.

The moving frame 220 of the side panel fixed-positioning jig 200 moves in a direction far away from the one of the side panels 3 of the body 1 along the width direction of the body 1 through the first driving unit 225.

The clampers 250, mounted on the support frame 240 through the post frame 230 on the moving frame 220, are moved in a direction far away from one of the side panels 3 of the body 1 by the moving frame 220.

In an exemplary form of the present disclosure, the support frame 240 is rotated by the driving motor 214, and the clampers 250 corresponding to the vehicle model of the body 1 are positioned at one of the side panels 3 of the body 1.

If the body 1 is positioned at the side panel fixed-positioning jig 200 of the brazing section 8 in the foregoing state, the moving frame 220 is moved to one of the side panels 3 side of the body 1 by the first driving unit 225, and the clampers 250 move to the preset position corresponding to the vehicle model of the body 1.

Next, the clampers 250 are moved forward to one of the side panels 3 side of the body 1 along the width direction of the body 1 by the second driving unit 253, and the upper portions of one of the side panels 3 are clamped by the clampers 250.

Next, while one of the side panels 3 of the body 1 is controlled by the clampers 250, the roof panel 5 aligned in the roof alignment jig 101 is unloaded from the roof alignment jig 101 by the roof loading jig 103, and the roof panel 5 is loaded on both side panels 3 of the body 1.

Here, the roof loading jig 103 unloads and loads the roof panel 5 while it is mounted on the handling robot 301. The roof loading jig 103 is separated from the handling robot 301 and the spot welding gun is mounted on the handling robot 301, while the roof panel 5 is loaded on both side panels 3 of the body 1 by the roof loading jig 103.

Next, the roof panel 5 and the front/rear roof rail parts are spot welded by one point by the spot welding gun of the handling robot 301 and the spot welding gun of the welding robot 105. Next, the spot welding gun is separated from the handling robot 301 and the roof pressing jig 300 is mounted on the handling robot 301.

Next, the roof pressing jig 300 is moved to the roof panel 5 side by the handling robot 301, and the roof panel 5 is pressed while being fixedly positioned by the roof pressing jig 300.

Describing in more detail the operation of the roof pressing jig 300, the jig frame 310 of the roof pressing jig 300 is moved to the roof panel 5 side by the handling robot 301.

Next, if the jig frame 310 is pressed to the roof panel 5 by the handling robot 301, a skin surface of both side edge portions are vacuum-adhered to by the vacuum cups 330, simultaneously with the control pad 320 supporting both side edge portions of the roof panel 5.

During the process, a control pin operating rod 343 is operated upward after the control pin operating rod 343 of the control pin cylinder 341 was operated downward.

Next, the control bracket 345, on which the control pin 340 is mounted, supports the lower surface of the roof panel 5 by the control pin operating rod 343, and the control pin 340 is upwardly inserted into the control hole 6a of the roof panel 5 from underneath, to control the roof panel 5.

Simultaneously therewith, the reference pin operating rod 363 is operated downward from the state in which the reference pin operating rod 363 of the reference pin cylinder 361 had operated upward.

Next, the reference pin 360 is downwardly inserted into a reference hole 6b of the roof panel 5 from above by the reference pin operating rod 363 to hold the reference position of the roof panel 5.

The docking bracket 317 of the jig frame 310 may be docked on the support bracket 233 of the side panel fixed-positioning jig 200 during the process of fixedly positioning and pressing the roof panel 5 by the roof pressing jig 300.

When the docking bracket 317 is docked to the support bracket 233, the fixed pin 235 of the support bracket 233 is coupled with the pin hole 319 of the docking bracket 317. Further, the pin clamper 237 on the support bracket 233 is rotated by the operation of the pin clamping cylinder 238, and the fixed pin 235 is clamped together with the docking bracket 317 by the operating pressure of the pin clamping cylinder 238.

Therefore, according to an exemplary form of the present disclosure, the roof panel 5 loaded on both side panels 3 of the body 1 may be fixedly positioned and pressed by the roof pressing jig 300 as described above.

The docking bracket 317 of the roof pressing jig 300 may be docked to the support bracket 233 of the side panel fixed-positioning jig 200, and the docking bracket 317 may be stably fixed to the support bracket 233 by the fixed pin 235 and the pin clamper 237.

The brazing assembly 400 is moved to the matching portions between one of the side panels 3 and the roof panel 5 by the brazing robot 401 while the roof panel 5 is pressed by the roof pressing jig 300.

Next, the sensor bracket 511 of the gap measurement unit 500 is moved forward to the matching portions between the one of the side panels 3 and the roof panels 5 by the operating cylinder 520.

The first profile sensor 510 fixed to the sensor bracket 511 approaches the matched portions of one of the side panels 3 and the roof panel 5, and the brazing robot 401 moves the first profile sensor 510 along the matching portions of one of the side panels 3 and the roof panel 5.

The first profile sensor 510 scans the matched portions between one of the side panels 3 and the roof panel 5 using the laser slit to measure the gaps between the matching portions. Here, the first profile sensor 510 sets a virtual reference line based on the straight part of the roof panel 5, and calculates the interval between the profiles generated on the reference line to measure the matching gaps between the roof panel 5 and one of the side panels 3.

The first profile sensor 510 transmits the matching gap measurement value between the roof panel 5 and one of the side panels 3 to the controller, and the controller applies the control signal to the second driving unit 253 of the side panel fixed-positioning jig 200 based on the gap measurement value of the roof panel 5 and one of the side panels 3

Next, the clampers 250 of the side panel fixed-positioning jig 200 controlling one of the side panels 3 of the body 1 are moved in the width direction of the body 1 by the second driving unit 253, and one of the side panels 3 moves and is fixedly positioned in the width direction of the body 1.

The gap between the matching portions may be measured by the gap measurement unit 500 before the matching portions between one of the side panels 3 and the roof panels 5 are bonded, by laser-brazing to each other by the brazing assembly 400.

The position of one of the side panels 3 is corrected by the side panel fixed-positioning jig 200 based on the gap measurement value between the roof panel 5 and one of the side panels 3, such that the matching gaps between the roof panel 5 and one of the side panels 3 may be set to zero.

As described above, the sensor bracket 511 of the gap measurement unit 500 is moved backward by the operating cylinder 520 while the matching gap between the roof panel 5 and one of the side panels 3 is set to zero through the correction of the position of one of the side panels 3 as described above.

Next, the brazing assembly 400 is moved along the bonding portions (matched portions) between one of the side panels 3 and the roof panel 5 by the brazing robot 401, and the bonding portions of one of the side panels 3 and the roof panel 5 are bonded, by laser-brazing, by the brazing assembly 400.

The brazing assembly 400 emits a laser beam irradiating the bonding portions of one of the side panels 3 and the roof panel 5 from the laser head 430 while avoiding the interference with the sensor bracket 511 using the operating cylinder 520, and supplies the filler wire 405 to the focal position of the laser beam through the wire feeder 450.

The brazing assembly 400 may melt the filler wire 405 using the laser beam as the heat source and may integrally bond, by brazing, the bonding portions of one of the side panels 3 and the roof panel 5 by melting the filler wire 405.

As described above, during the process of bonding, by brazing, the bonding portions of one of the side panels 3 and the roof panel 5 by the brazing assembly 400, air is supplied to the air injection path 555 of the sensor bracket 511 through the air blower 550.

Next, the air supplied through the air blower 550 is injected in the direction vertical to the irradiation direction of the laser beam through the air injection path 555 to prevent foreign materials from being attached to the bonding portions of one of the side panels 3 and the roof panel 5 being bonded by laser-brazing.

As described above, as the bonded portions of one of the side panels 3 and the roof panel 5 are bonded to each other by laser-brazing by the brazing assembly 400, the bonding portions are provided with the brazing-beads.

The side panel fixed-positioning jig 200 and the roof pressing jig 300 return to an original position when the bonded portions of both side panels 3 of the body 1 and the roof panels 5 are bonded, by laser-brazing, to each other by the above-mentioned process.

Next, the roof pressing jig 300 is separated from the handling robot 301 and the spot welding gun is mounted on the handling robot 301. Next, the roof panel 5 and the front/rear roof rail parts are spot-welded by the spot welding gun of the handling robot 301 and the spot welding gun of the welding robot 105.

Next, the body 1 is transferred to the grinding section 9 along the transfer line 7, and then the grinding assembly 600 is moved to the brazing-bead sides of the bonding portions of one of the side panels 3 and the roof panel 5 by the grinding robot 601 in the grinding section 9.

The grinding wheel 630 of the grinding assembly 600 may be newly mounted on the grinding motor 620 before the grinding assembly 600 moves to the brazing-bead sides of the bonding portions of one of the side panels 3 and the roof panel 5.

In this case, since the grinding assembly 600 is moved along the predetermined taught path by the grinding robot 601, and grinds the brazing-beads with the grinding wheel 630, the grinding surface of the grinding wheel 630 is positioned below the reference position based on the position of the brazing-bead.

Therefore, a stopper operating rod 671 of the stopper cylinder 670 moves backward, and the movement restriction of the grounding motor 620 is released. Next, the grinding motor 620 is moved downward, by the moving plate 650, together with the grinding wheel 630, under its own weight.

In this state, the separate support means 603 applies the external force to the grinding wheel 630 to upwardly move the grinding motor 620 together with the grinding wheel 630 by the moving plate 650, and positions the grinding surface of the grinding wheel 630 at the reference position.

Next, the stopper operating rod 671 of the stopper cylinder 670 moves forward, and the movement of the grinding motor 620 is limited by the friction pad 675 adhering to the front end of the stopper operating rod 671.

As described above, the grinding assembly 600 moves toward the brazing-bead side, and then the position of the body 1 is sensed by the vision camera 730 of the bead checking unit 700 mounted on the grinding robot 601 together with the grinding assembly 600.

The vision camera 730 vision photographs the front glass mounting hole of the body 1 and the brazing portion of the center filler side, and outputs the vision data to the controller. Next, the controller may analyze the vision data received from the vision camera 730 to calculate the position value of the body 1 and compare the calculated value with the reference value (reference position value of the body) to correct the grinding position of the grinding assembly 600.

Next, the grinding wheel 630 is rotated by the grinding motor 620, the grinding wheel is moved along the brazing-bead by the grinding robot 601, and the brazing-bead is ground by the grinding wheel 630.

The grinding dust scattered when the brazing-bead is ground is collected in the wheel cover 640 enclosing the grinding wheel 630 and the grinding dust is sucked through the inlet 645 of the wheel cover 640 and discharged to the outside of the wheel cover 640. The pressure control cylinder 660 may control the grinding pressure of the grinding wheel 630 applied to the brazing-bead.

The grinding wheel 630 grinds the brazing-bead and thus the grinding wheel 630 is worn.

In this case, since the grinding assembly 600 is moved along the predetermined taught path by the grinding robot 601, and grinds the brazing-beads by the grinding wheel 630, the grinding surface of the grinding wheel 630 is positioned above the reference position based on the position of the brazing-bead.

Therefore, a stopper operating rod 671 of the stopper cylinder 670 moves backward and the movement restriction of the grounding motor 620 is released. Next, the grinding motor 620 moves downward together with the grinding wheel 630 under its own weight, and the grinding surface of the grinding wheel 630 is positioned at the preset position by the support means 603.

Next, the stopper operating rod 671 of the stopper cylinder 670 moves forward and the movement of the grinding motor 620 is limited by the friction pad 675 adhering to the front end of the stopper operating rod 671.

The grinding bracket 610 of the grinding assembly 600 is rotated by the grinding robot 601 when the brazing-bead is ground by the grinding assembly 600.

Next, the mounting bracket 710 of the bead checking unit 700 rotates together with the grinding bracket 610, and the vision camera 730 and the second profile sensor 750 of the bead checking unit 700 are positioned at the ground brazing-bead side.

Next, the bead checking unit 700 moves along the ground brazing-bead by the grinding robot 601 to vision photograph the ground brazing-bead using the vision camera 730 and output the vision data to the controller.

The controller analyzes the vision data received from the vision camera 730 to calculate the width of the ground brazing-bead, and compares the calculated value with the reference value (reference value of the ground brazing-bead) to detect the defects of the ground brazing-bead.

The cross section of the ground brazing-bead is sensed in a two-dimensional profile form by the second profile sensor 750, and the detection signal is output to the controller.

The controller analyzes the detection signal received from the second profile sensor 750 to calculate the height of the ground brazing-bead, and compares the calculated value with the reference value (reference value of the ground brazing-bead) to detect the defects of the ground brazing-bead.

As described above, if the defects of the brazing-bead are detected by the bead checking unit 700, the detected results are displayed by a display and are transmitted to a repair process and quality history management server.

If defects of the so ground brazing-bead are detected, the grinding robot 601 returns to an original position, and the body 1 bonded to the roof panel 5 is transferred to the subsequent process through the transfer line 7.

Therefore, the roof laser-brazing system 100 may bond the roof panel 5 to both side panels 3 based on the body 1 using a series of processes as described above by the laser-brazing method.

By doing so, according to an exemplary form of the present disclosure, the bonding portions of both side panels 3 of the body 1 and the roof panel 5 are bonded to each other by the brazing assemblies 400 using the laser-brazing method, thereby eliminating the roof molding of the related art.

Further, according to an exemplary form of the present form, the roof molding of the related art is omitted, such that the appearance of the body may be aesthetic, the material costs may be saved, and the labor costs due to the mounting of the roof molding may be saved.

Further, according to an exemplary form of the present disclosure, the roof panel 5 may be controlled to be fixedly positioned at both side panels 3 by the roof pressing jig 300, the gaps between both side panels 3 and the roof panel 5 may be set to zero by the side panel fixed-positioning jigs 200 and the gap measurement units 500, both side panels 3 and the roof panel 5 may be bonded, by laser-brazing, to each other, and the grinding defects of the brazing-beads may be automatically detected by the bead checking units 700, such that the quality of the bonding by brazing of the roof panel 5 may be more improved.

Further, according to an exemplary form of the present disclosure, roof panels 5 may be bonded, by laser-brazing, to bodies 1 of multiple respective vehicle models, such that multiple vehicle models may be flexibly produced, the facility preparation time may be reduced, the weight reduction and simplification of the whole facilities may be improved, and the investment costs at the early stage and at the time of adding the vehicle model may be saved.

Although exemplary forms of the present disclosure are described above, the technical ideas of the present disclosure are not limited to the exemplary forms disclosed in the present specification and therefore those skilled in the art understanding the technical ideas of the present disclosure may easily suggest other exemplary forms by supplementing, changing, deleting, adding, and the like of components within the scope of the same technical ideas, and it is to be noted that these suggested forms are included in the scope of the present disclosure.

What is claimed is:

1. A brazing assembly for a roof laser-brazing system, the roof laser-brazing system including a brazing section and a grinding section set along a transfer path of a body to bond a roof panel to two side panels based on the body including both side panels, the brazing assembly configured to, when both side panels and the roof panel are fixedly positioned by side panel fixed-positioning jigs and a roof pressing jig, bond one of the side panels to the roof panel by brazing a bonding portion of one of the side panels and a bonding portion of the roof panel using a laser as a heat source, the brazing assembly for the roof laser-brazing system comprising:
a brazing bracket configured to be mounted to at least one brazing robot in the brazing section;
a laser head mounted to the brazing bracket and configured to emit a laser beam to irradiate the bonding portion of one of the side panels and the bonding portion of the roof panel; and
a wire feeder mounted to the brazing bracket and configured to supply a filler wire to a focal position of the laser beam.

2. The brazing assembly of claim 1, wherein the brazing bracket is connected to a gap measurement unit configured to measure a matching gap between the roof panel and one of the side panels.

3. The brazing assembly of claim 1, wherein the brazing bracket has a U-shape, and corner portions of the brazing bracket are connected to reinforcing plates.

4. The brazing assembly of claim 2, wherein the gap measurement unit includes a profile sensor mounted to the brazing bracket and configured to scan matching portions of one of the side panels and of the roof panel to measure a gap between the matching portions.

5. The brazing assembly of claim 4, wherein the profile sensor is configured to:
set a virtual reference line based on a straight portion of the roof panel;
calculate an interval between profiles generated on the reference line; and
measure the matching gap between the roof panel and one of the side panels.

6. The brazing assembly of claim 4, wherein the profile sensor is mounted to the brazing bracket and configured to be moved forward and backward by an operating cylinder.

7. The brazing assembly of claim 4, wherein the brazing bracket is fixedly mounted to an operating cylinder, and an operating rod of the operating cylinder is connected with a sensor bracket to which the profile sensor is fixed.

8. The brazing assembly of claim 7, wherein the operating cylinder is connected to a pair of guide bars configured to guide the sensor bracket when the sensor bracket is moved forward and backward by the operating rod.

9. The brazing assembly of claim 7, wherein the sensor bracket is connected to an air blower to inject air.

10. The brazing assembly of claim 9, wherein the sensor bracket comprises an air injection path connected to the air blower, and the brazing assembly is configured to inject air through the air injection path in a direction vertical to an irradiation direction of the laser beam.

11. The brazing assembly of claim 10, wherein the air injection path is formed in the sensor bracket along a vertical direction, and the brazing assembly is configured to inject air through a lower end thereof.
